(19) United States
(12) Patent Application Publication
(10) Pub. No.: US 2006/0144448 A1
(43) Pub. Date: Jul. 6, 2006

(54) Production of variable concentration fluid mixtures

(76) Inventor: Brian Arthur Goody, MIDDLESEX (GB)

Correspondence Address: Intellectual Property Department;DeWitt Ross & Stevens, Firstar Financial Centre, 8000 Excelsior Drive, Suite 401, Madison, WI, 53717-1914, US

(21) Appl. No.: 10/526,419

(22) PCT Filed: Aug. 27, 2003
(86) PCT No.: PCT/GB03/03779

§ 371 Date: Oct. 21, 2005

(30) Foreign Application Priority Data
Sep. 2, 2002 (GB) 0220338.8

(51) Int. Cl. B01F 15/04

(52) U.S. Cl. 137/599.01

(57) ABSTRACT

In a fluid mixing device calibration and complementary gases are supplied to constant flow devices (10,12). The flows through devices (10,12) are adjusted to be equal. The two gas flows are connected to switching valves (14,16), which allow the gas flows to be either vented or fed to the frequency multiplier (18). The two valves (14,16) are coupled to switch simultaneously but in opposite positions. Thus, the flow rate into the frequency multiplier (18) is constant but may be switched to comprise either calibration or complementary gas. The frequency multiplier divides the input stream into a number of equal streams which, after different time delays have been introduced, are recombined to produce a single stream of reduced concentration ripple and periodicity. The output from the frequency multiplier (18) fed to a series of chambers (20-24) where each chamber produces an attenuation of the concentration ripple and a time response to a change in concentration. As the attenuations of the chambers (20-24) are multiplicative and the time responses are additive, multiple chambers give a higher ratio of ripple attenuation to time response than does a single chamber. Better and faster production of substantially homogenized fluid mixtures is possible.

The present invention relates to the production of variable concentration fluid mixtures. In the preferred embodiment, there is provided the production of variable concentration fluid mixtures by mixing discontinuous flows of calibration fluid and complementary fluid and the conditioning of the resultant mixture to have low concentration fluctuations (ripple) and constant flow rate while providing a rapid response to change of concentration.

Discontinuous flows of calibration and complementary fluids are currently produced by repeatedly pumping defined volumes of the fluids at variable frequencies, or switching fixed flows of fluids for variable time periods. These methods can be controlled to produce the desired average fluid concentration but conditioning is needed to reduce ripple in the concentration and flow rate. This conditioning is most simply achieved by a single chamber that integrates the concentration and flow fluctuations. Baffles may be included in the chamber to aid mixing.

Current techniques do not provide constant flow and constant concentration. To achieve low flow and concentration ripple the discontinuous flow is passed through a mixing (integrating) chamber. Ripple reduction is improved as chamber volume is increased. This chamber has the disadvantage of introducing a long time response to a change of concentration. Time response is increased as chamber volume is increased.

The concentration ripple and flow rate ripple may be reduced by increasing the pumping or switching frequency, or by increasing the volume of the integrating chamber, but these methods create problems. The former tends to increase errors in the average concentration because switching valve transition times become significant, while the latter increases the time required to respond to a change of average concentration.

The present invention seeks to provide improved production of variable concentration fluid mixtures.

According to an aspect of the present invention, there is provided, a method of providing variable concentration fluid mixtures including the step of providing equal flows of at least first and second fluid components, selectively switching the flows to a mixing stage for durations related to the intended concentration, wherein said selective switching provides an outputted fluid mixture at a substantially constant outward flow.

Advantageously, the method includes the step of mixing the components through a frequency multiplier and/or of passing the fluid mixture through a plurality of integrating chambers.

According to another aspect of the present invention, there is provided a method of modifying the ripple in a fluid mixture produced by mixing a plurality of fluid components together including the step of feeding the fluid mixture through a plurality of integrating chambers.

According to another aspect of the present invention, there is provided apparatus for modifying concentration ripple produced my mixing a plurality of fluid components together including a mixture inlet, a mixture outlet and a plurality of conduits between the inlet and the outlet operable to allow passage of mixture from the inlet to the outlet at different flow times, thereby providing frequency multiplication of concentration ripple.

Advantageously, the inlet and outlet are provided by first and second substantially concentric tubes closed at one end thereof and the conduits are provided as apertures in the innermost tube between inlet and outlet provided by the tubes.

Alternatively, the inlet and outlet are provided by first and second adjacent tubes closed at one end thereof and the conduits are provided as capillaries between the inlet and outlet tubes.

According to another aspect of the present invention, there is provided a fluid mixture integrating assembly including a plurality of integrating chambers.

According to another aspect of the present invention, there is provided a fluid mixing assembly including apparatus as specified herein. Advantageously, the assembly includes flow devices operable to provide equal flows of first and second fluid components, switching means operable selectively to switch the flows to a mixing stage for durations related to the intended concentration, wherein said selective switching provides an outputted fluid mixture at a substantially constant outward flow.

According to another aspect of the present invention, there is provided a method of producing variable concentration fluid mixtures including the step of providing components at a substantially constant flow rate and switching supply of the components at a substantially constant frequency.

Advantageously, concentration ripple produced by mixing is frequency multiplied and its amplitude divided before integration. In the preferred embodiment, an integrating volume of mixed components is sub-divided into smaller chambers, in series.

According to another aspect of the present invention, there is provided a method of providing variable concentration fluid mixtures in which equal flows of components of the mixture are provided to give a constant outward flow.

According to another aspect of the present invention, there is provided a fluid mixture integrating assembly including a plurality of integrating chambers.

Embodiments of the present invention are described below, by way of example only, with reference to the accompanying drawings, in which:

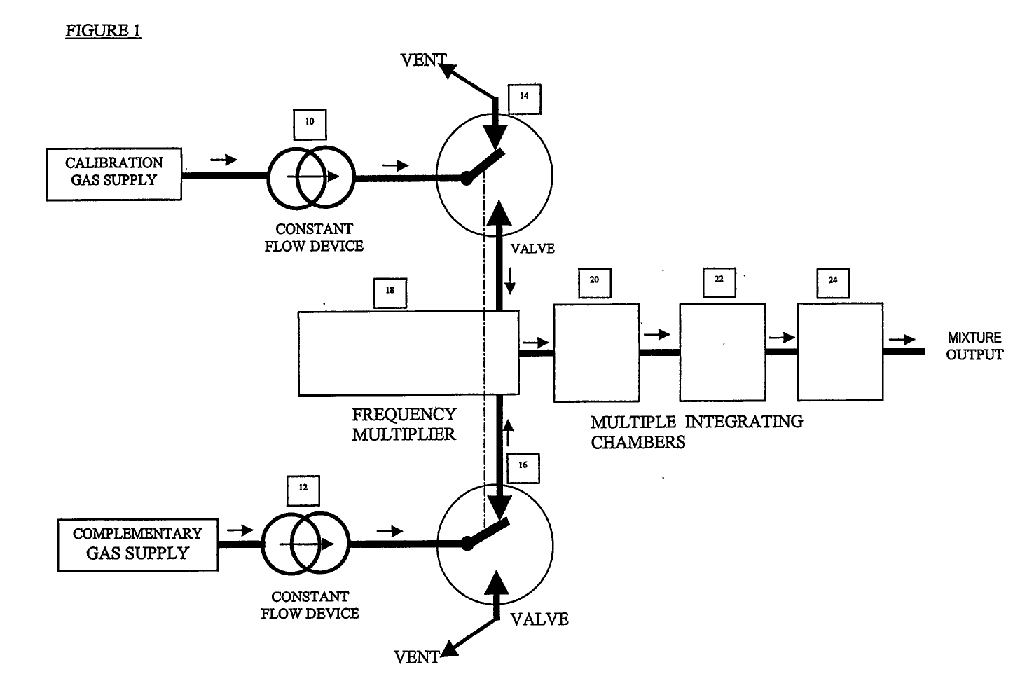

FIG. 1 shows in schematic form a block diagram of a system for producing variable concentration fluid mixtures;

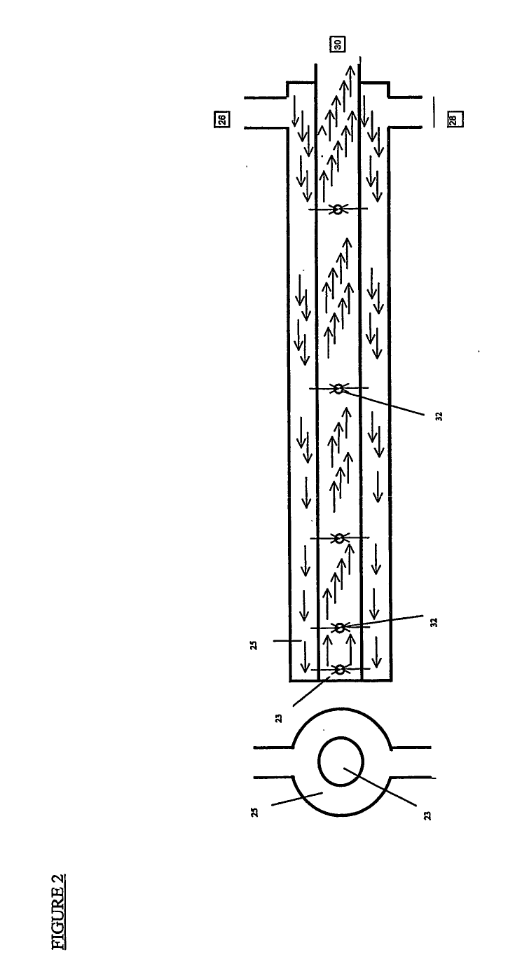

FIG. 2 shows an embodiment of frequency multiplier for the apparatus of FIG. 1, both in transverse and in axial cross-section;

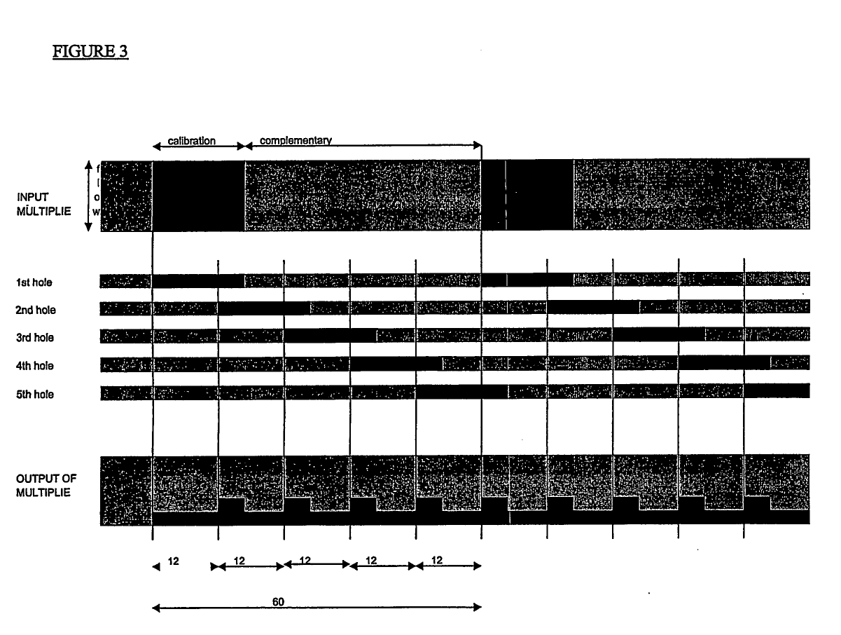

FIG. 3 illustrates the operation of the frequency multiplier of FIG. 2;

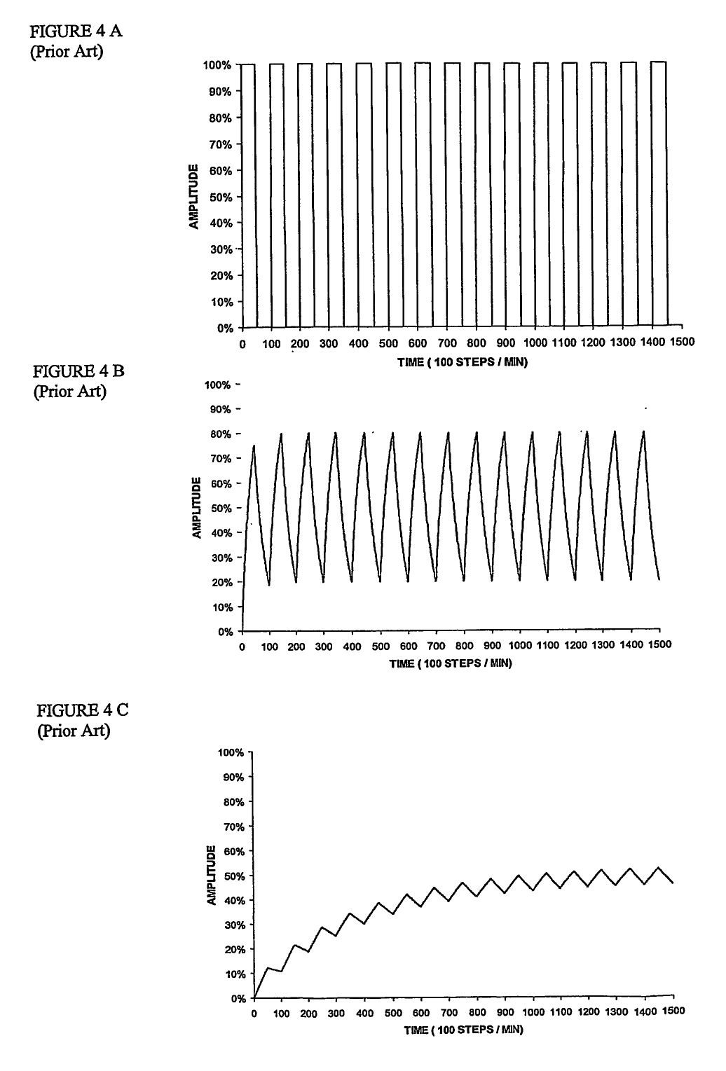

FIGS. 4a to 4c show the performance of a conventional fluid mixing technique;

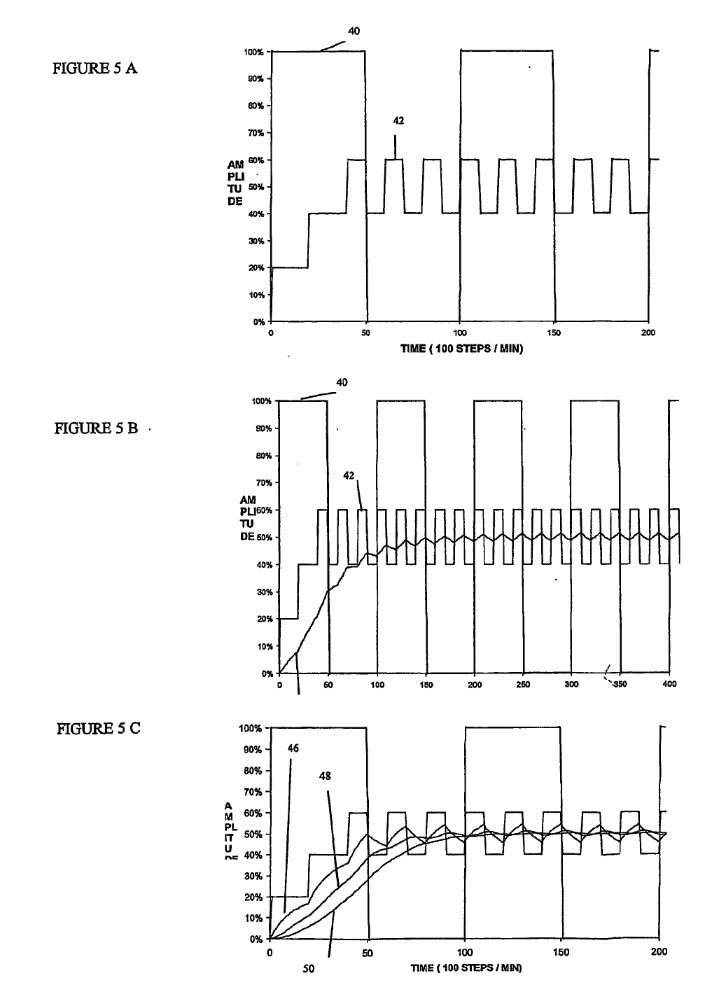

FIGS. 5a to 5c show the results of the preferred embodiment of technique.

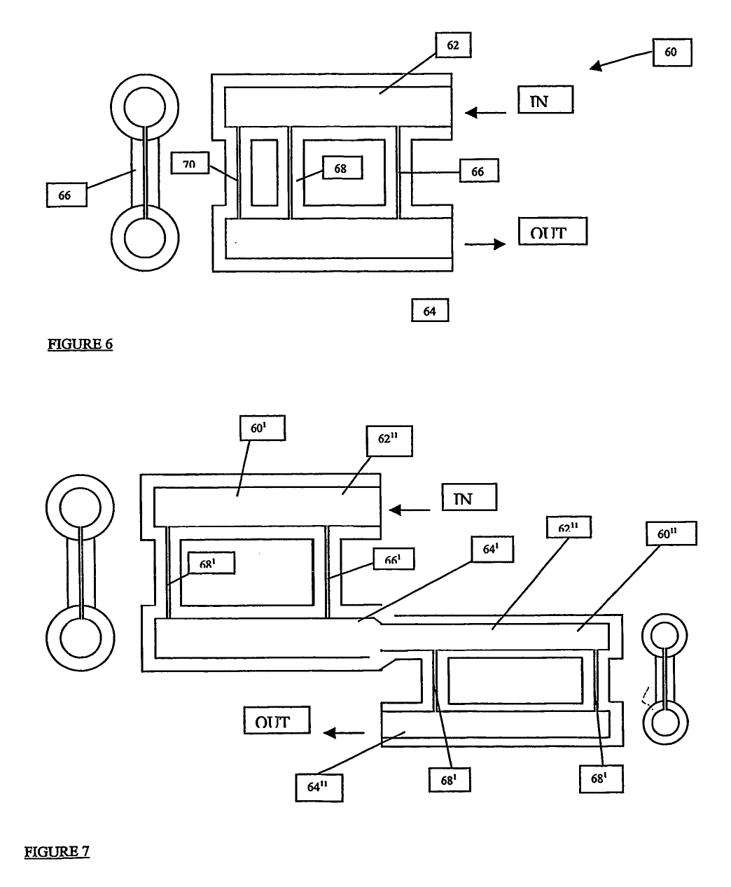

FIG. 6 shows another embodiment of frequency multiplier, both in transverse and in axial cross-section;

FIG. 7 shows another embodiment of frequency multiplier, both in transverse and in axial cross-section;

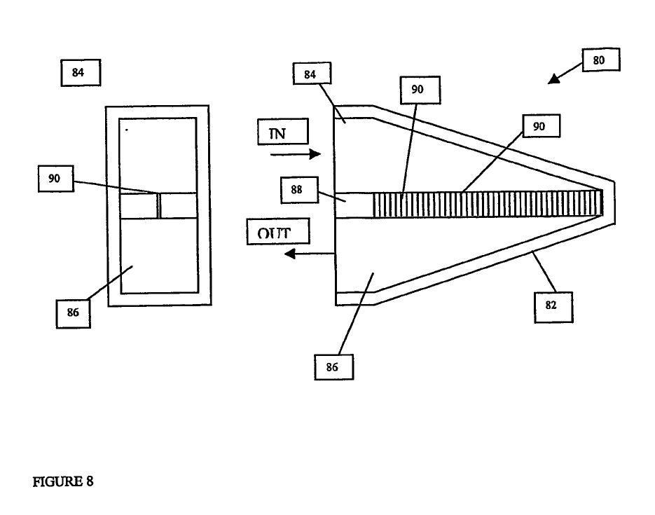

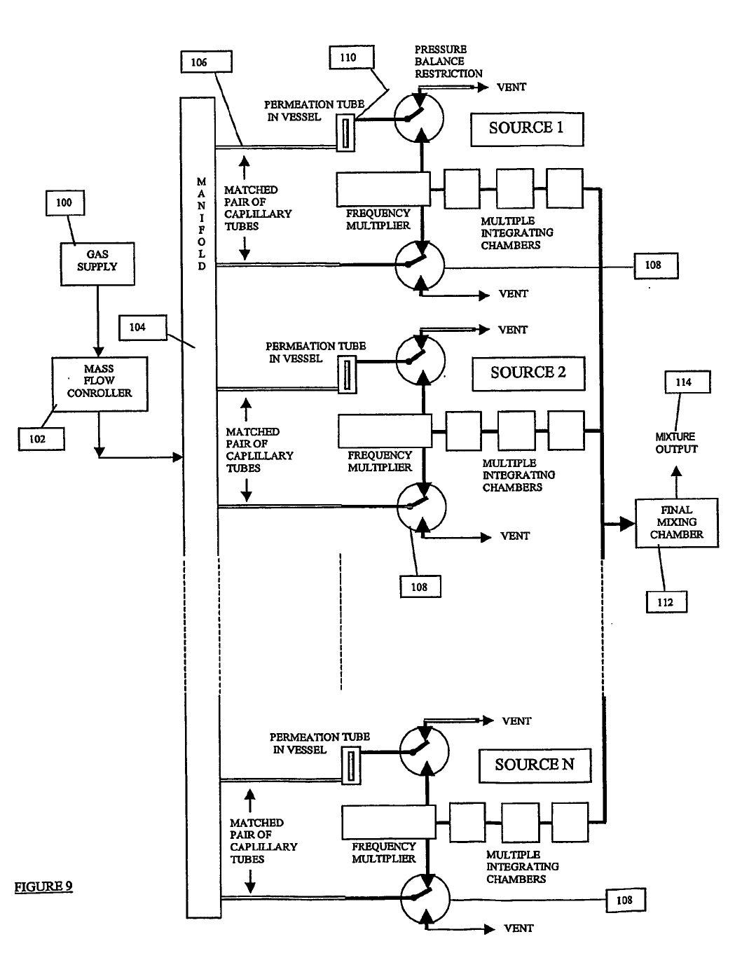

FIG. 8 shows another embodiment of frequency multiplier, both in transverse and in axial cross-section; and

FIG. 9 shows an embodiment of multi-component mixture assembly.

An embodiment of the present invention is described in FIG. 1, in which complementary gas dilutes a calibration gas mixture. Calibration and complementary gases are supplied to constant flow devices 10 and 12, respectively. One example of a constant flow device is a mass flow controller. The flows through devices 10 and 12 are adjusted to be equal. The two gas flows are connected to switching valves 14 and 16, which allow the gas flows to be either vented or fed to the frequency multiplier 18. The two valves 14, 16 are coupled to switch simultaneously but in opposite positions. Thus, the flow rate into the frequency multiplier 18 is constant but may be switched to comprise either calibration or complementary gas.

Selecting the proportion of time for which the calibration gas is turned on varies the average concentration of the gas mixture entering 18. In the preferred embodiment, the period between pulses of calibration gas being initiated is made constant and of a sufficiently long time duration to make the transition time of the switching valves insignificant. In an example the valves have a transition time of 10 milliseconds and the switching period is 60 seconds.

Thus, the input to the frequency multiplier 18 is a constant flow rate of gas that is switched in concentration between zero and that of the calibration gas with a period of 60 seconds and a variable on-time of 0 to 60 seconds, representing an average concentration of 0 to 100% of the calibration gas concentration.

The peak-to-peak amplitude of the concentration ripple at the input to the frequency multiplier 18 is equal to the calibration gas concentration and has a 60 second period. The concentration ripple may be reduced by feeding the flow through an integrating chamber assembly 20 to 24, but this will also slow the time response to a demanded change in average concentration. If the period of the ripple is reduced, by frequency multiplication, the concentration ripple may be reduced to the same level by a smaller integrating chamber, with less reduction in time response.

In this example, the output from the frequency multiplier 18 is not fed to a single integrating chamber, but to a series of chambers 20 to 24 (in this example three are shown). Each chamber 20-24 produces an attenuation of the concentration ripple and a time response to a change in concentration. As the attenuations of the chambers 20 to 24 are multiplicative and the time responses are additive, multiple chambers give a higher ratio of ripple attenuation to time response than does a single chamber.

An example of a frequency multiplier 18 is shown in FIG. 2. The arrows represent units of flow at various sections. It comprises two concentric tubes 23, 25. The calibration and complementary gases enter at ports 26 and 28 and exit at port 30. The central tube 23 has five equal holes 32 in its wall. The gas flows, with negligible pressure drop because of the relatively large cross-section, from right to left through the space between the tubes 23, 25. Close to one fifth of the total flow goes through each of the five holes 32 and enters the internal tube 23 where it flows from left to right, again with negligible pressure drop, and flows out through port 30.

The five holes 32 are spaced such that, taking into account the cross-section of the tubes 23, 25 and the flow rate of the gas, the five flows are successively time-delayed by multiples of 0, ⅕, ⅖, ⅗ and ⅘ of the period, with respect to the first hole.

FIG. 3 illustrates the operation of the frequency multiplier 18. The top bar represents the input to the frequency multiplier 18 with the vertical axis indicating flow rate (which is constant) and the horizontal axis indicating time. The shading shows the concentration switching between that of the calibration gas and the complementary gas with a period of 60 seconds. The time for which the calibration gas flows determines the concentration averaged over one period. The five bars below represent flow and concentration of the flows through the five holes. These are added to give the final output. The bottom bar shows the discrete proportions of calibration and complementary gases in the output mixture and the reduced ripple period of 12 seconds.

FIGS. 4A, 4B and 4C show an example of the performance achieved with current techniques. FIG. 4A shows the amplitude of the concentration from the valves being switched between 0% and 100% with a period of 60 seconds (100 steps). The horizontal scale is time. In this example the 100% concentration is present for half the time, to give an average concentration of 50%. The concentration ripple amplitude is 100%.

FIG. 4B shows how the ripple amplitude is reduced by the addition of a single integrating chamber of 20 ml volume. The ripple amplitude is approximately 60% and the time for the concentration to rise from its initial value of zero to a point where the average is 50% is approximately 1.5 minutes.

FIG. 4C is similar to FIG. 4B but the single integrating chamber volume is increased to 200 ml. The ripple amplitude is approximately 6% and the time for the concentration to rise from its initial value of zero to a point where the average is 50% is approximately 15 minutes.

FIGS. 5A, 5B and 5C show an example of the performance theoretically achieved with the use of a frequency multiplier 18 and three integrating chambers. There will in practice be some degradation depending on the implementation. FIG. 5A shows (trace 40) the amplitude of the concentration from the valves being switched between 0% and 100% with a period of 60 seconds (100 steps). The timescale is reduced compared to that of FIGS. 4A to 4C. In this example the 100% concentration is again present for half the time, to give an average concentration of 50%. This Figure also shows (trace 42) the output of the frequency multiplier. In this example the frequency is multiplied five times and the concentration ripple amplitude is reduced to 20%.

FIG. 5B is similar to FIG. 5A but also shows (trace 44) the output after the addition of a single 20 ml integrating chamber. The ripple amplitude is approximately 3% and the time for the concentration to rise from its initial value of zero to a point where the average is 50% is approximately 1.5 minutes.

In FIG. 5C the single chamber of FIG. 5B is replaced by three chambers each having a volume ⅓ of that of the single chamber. The traces 46, 48, 50 show the outputs of the consecutive chambers. The ripple amplitude is attenuated at each chamber and is finally less than 1%. The time for the concentration to rise from its initial value of zero to a point where the average is 50% is approximately 1.5 minutes.

Referring now to FIG. 6, there is shown another embodiment of frequency multiplier 60. This embodiment is designed to provide three times multiplication and functions in a similar manner to the embodiment shown in FIG. 2. The concentric tubes and holes are replaced by first and second adjacent tubes 62 and 64 which are connected together by three capillaries 66, 68 and 70. The capillaries 66-70 give good control of the three split flows. Of course, the number of capillaries provided could be different from the example shown in FIG. 6, with the distance between the capillaries being as per the distances of the apertures of the embodiment of FIG. 2.

FIG. 7 shows an embodiment of multiplier similar to that of FIG. 6, arranged to provide, in this example, four times multiplication. More specifically, two multiplier assemblies 60′ and 60″ are connected together such that the outlet 64′ of the first multiplier 60′ is connected to the inlet 62″ of the second multiplier 60″. In this embodiment, each multiplier 60′, 60″ is provided with two capillaries 66′, 68′ and 66″, 68″ to provide each multiplication by two, such that together they generate multiplication by four times. Of course, the multiplier can be changed by varying the number and position of capillaries 66′68 in each multiplier.

It can be seen in the embodiment of FIG. 7 that the second stage multiplier 60″ has reduced cross-section tubes 62″ and 64″, which provides faster flow rate and effectively increases the relative distance between its two capillaries.

FIG. 8 shows another embodiment of multiplier 80, which is provided with a tapering housing 82 which contains both the inlet and the outlet tubes 84, 86, respectively. Separating the inlets and the outlets 84, 86 is a wall 88 provided with a series of equally spaced capillaries 90 connecting the inlet and the outlet 84, 86 together. The reducing cross-sectional areas of the inlet and the outlet 84, 86 provides the required flow multiplication, hence the ability to keep the spacing between the capillaries equal. At the limit, the capillaries 90 could be replaced by a continuous slot.

Referring now to FIG. 9, since the dilution systems described herein provide constant output flow rate for all selected dilutions, it is possible to add the outputs of several dilutors to create multi-component mixtures in which the concentration of each component is variable, by dilution, without causing a change in the concentration of the other components.

An example of multiple dilutors is shown in FIG. 9. It comprises a number of devices similar to that of FIG. 1. A gas supply 100, normally providing clean dry air that has had other gas species removed, is defined by a mass flow controller 102 that feeds into a manifold 104 and supplies a number of capillary tubes 106. Each of the sources 1 to N has a matched pair of capillaries 106 to provide two substantially equal flows. The lower flow passes directly to a solenoid valve 108 while the upper flow first passes through a vessel that contains a permeation tube device 110. The permeation tube 110 adds a small amount of its contents (typically benzene, sulphur dioxide, etc) to the air stream at a steady, measurable rate. This forms a calibration gas mixture.

The other sources, 1 to N, are similar but it is not necessary that their capillary pairs are all identical, only that pairs are matched. This ensures that the flow from the mass flow controller 102 is split equally between that which is vented and that which provides the mixture output.

The outputs of each stage or source 1 to N are then combined in a final mixing chamber 112 to provide a mixed gas output 114. A device able to mix up to 30 gases has been provided with this arrangement, the limiting depending in practice upon space/size considerations and needs of the user.

At present it is preferred that the volume of the chamber is half the flow in a period.

Various modifications to the described embodiments can be made, some examples being given below.

The constant flow devices and switching valves may take various forms. The flows could be interrupted by halting rather than diverting. The feature of switching equal flows to give a constant output flow could be used independently. The concentration frequency multiplier could be used independently, one example being as an analogue mixing device. The multiple integrating chambers could be used independently. The frequency multiplier could be configured in various ways.

The technique splits the flows, delays them and recombines them. The multiplying factor may be varied. Frequency multipliers could be cascaded in series. The output of a diluting device could be used to provide the input to another diluting device. The number of serial integrating chambers may be increased or decreased. The distribution of volumes of the integrating chambers may be varied.

The technique could be used with all fluids, mixtures of fluids and fluid mixtures containing solid matter, indeed with any materials which are able to flow. It could be used with all scales of fluid flow from industrial pipe sizes to nanotechnology; with multiple calibration fluids and a frequency multiplier with multiple inputs, provided the output flow is constant.

Outputs from any number of the diluting devices may be combined together to provide independent dilution control.

Concentration dilution by discontinuous flows of calibration and complementary fluids is achieved with constant output flow rate, low concentration ripple and fast response to change of concentration.

It will be apparent from the teachings herein that the frequency multipliers described could be modified to provide different multiplication factors, by suitable selection of holes/capillaries and combinations, as shown, for example, with the embodiment of FIG. 7.

The disclosures in British patent application no. 0220338.8, from which this application claims priority, and in the abstract accompanying this application are incorporated herein by reference.

1. A method of providing variable concentration fluid mixtures including the step of providing equal flows of at least first and second fluid components, selectively switching the flows to a mixing stage for durations related to the intended concentration, wherein said selective switching provides an outputted fluid mixture at a substantially constant outward flow.

2. A method according to claim 1, including the step of mixing the components through frequency multiplication.

3. A method according to claim 2, wherein frequency multiplication provides the steps of feeding the fluid mixture into an inlet of a frequency multiplier, passing the fluid mixture from the inlet through a plurality of spaced conduits to an outlet of the frequency multiplier, the mixture passing through the plurality of conduits at different flow times, thereby providing frequency multiplication of concentration ripple.

4. A method according to claim 2, wherein the step of fluid multiplication multiplies the frequency of the concentration ripple and to divide its amplitude.

5. A method according to claim 1, including the step of passing the fluid mixture through a plurality of integrating stages.

6. A method according to claim 5, wherein there are provided at least two integrating stages.

7. A method according to claim 1, wherein the step of selectively switching the flows provides switching at a substantially constant frequency.

8. A method of modifying the ripple in a fluid mixture produced by mixing a plurality of fluid components together including the step of feeding the fluid mixture through a frequency multiplier which operates to multiply the frequency of the concentration ripple and to divide its amplitude.

9. A method according to claim 8, wherein the frequency multiplier provides at least two times multiplication.

10. A method according to claim 8, including the step of feeding the fluid mixture through a plurality of integrating chambers.

11. A method of modifying the ripple in a fluid mixture produced by mixing a plurality of fluid components together including the step of feeding the fluid mixture through a plurality of integrating chambers.

12. Apparatus for modifying concentration ripple produced by mixing a plurality of fluid components together including a mixture inlet, a mixture outlet and a plurality of conduits between the inlet and the outlet operable to allow passage of mixture from the inlet to the outlet at different flow times, thereby providing frequency multiplication of concentration ripple.

13. Apparatus according to claim 12, wherein the inlet and outlet are provided by first and second substantially concentric tubes closed at one end thereof and the conduits are provided as apertures in the innermost tube between inlet and outlet provided by the tubes.

14. Apparatus according to claim 13, wherein the inlet and outlet are provided by first and second adjacent tubes closed at one end thereof and the conduits are provided as capillaries between the inlet and outlet tubes.

15. Apparatus according to claim 14, wherein the adjacent tubes are located in a common housing and the capillaries are located in a wall separating the inlet and the outlet in the housing.

16. Apparatus according to claim 12, wherein the spacing between adjacent conduits decreases from an entrance to each of the inlet and the outlet.

17. Apparatus according to claim 12, wherein the cross-sectional areas of each of the inlet and the outlet decreases from an entrance thereof.

18. Apparatus according to claim 12, wherein the inlet and outlet and the conduits are formed of or coated with glass.

19. A fluid mixture integrating assembly including a plurality of integrating chambers.

20. The apparatus of claim 12 further comprising:
a. flow devices operable to provide equal flows of first and second fluid components, and
b. a switch operable selectively to switch the flows to a mixing stage for durations related to the intended concentration, wherein said selective switching provides an outputted fluid mixture at a substantially constant outward flow.

21. The fluid mixture integrating assembly of claim 19 further comprising:
a. flow devices operable to provide equal flows of first and second fluid components, and
b. a switch operable selectively to switch the flows to a mixing stage for durations related to the intended concentration, wherein said selective switching provides an outputted fluid mixture at a substantially constant outward flow.
